(19) United States
(12) Patent Application Publication
(10) Pub. No.: US 2023/0261214 A1
(43) Pub. Date: Aug. 17, 2023

(54) FUEL CELL

(71) Applicant: TOYOTA JIDOSHA KABUSHIKI KAISHA, Toyota-shi (JP)

(72) Inventors: Hiroyuki KAWAI, Toyota-shi (JP); Masaki ANDO, Toyota-shi (JP); Yusuke OTSU, Toyota-shi (JP)

(21) Appl. No.: 18/148,512

(22) Filed: Dec. 30, 2022

(30) Foreign Application Priority Data
Feb. 16, 2022 (JP) 2022-021905

(51) Int. Cl. H01M 8/026; H01M 8/0263; H01M 8/0267; H01M 8/04029

(52) U.S. Cl. CPC H01M 8/026; H01M 8/0263; H01M 8/0267; H01M 8/04029

(57) ABSTRACT

Provided is a fuel cell having excellent gas diffusivity and leading to suppressed pressure drop even with a porous body as a gas path. The fuel cell includes: plural stacked power generating unit cells each having a membrane assembly, an anode separator stacked on the membrane assembly on one side, and a cathode separator stacked on the membrane assembly on the other side, wherein the anode separator of any one of the power generating unit cells is stacked on the cathode separator of another one thereof that is adjacent to said any one, the cathode separator has a porous body where an oxidizing gas flows, and a path enlarging member, and the path enlarging member includes gas path enlarging portions that enlarge a path formed by the porous body, the gas path enlarging portions having wall parts inclining or orthogonal to a direction where the oxidizing gas flows.

### FIELD

The present disclosure relates to a fuel cell.

### BACKGROUND

Patent Literature 1 discloses a fuel cell provided with a porous metal that is used for a gas path on a cathode side.

Patent Literature 2 discloses that a cathode-side gas flow path of a cell that is a component of a fuel cell is formed by a first expanded metal arranged on a gas inlet side, and a second expanded metal arranged on a downstream side. In the first expanded metal, meshes are arranged in a straight line, so that a gas flowing on a gas diffusion layer side is separated from a gas flowing on a separator side.

Patent Literature 3 discloses that plural minute grooves are formed in a face opposite to a separator so as to extend in a direction of crossing the flowing direction of an oxidizing gas that in a cathode-side porous body flow channel.

Patent Literature 4 discloses that in a fuel cell, a first porous body is provided between first metal separators and a membrane electrode assembly. A first oxidizing gas flow field extending in a wavy pattern as a passage of an oxidizing gas is formed in the first porous body. A second oxidizing gas flow field extending in a straight pattern as a passage of a reactant gas is formed in the first metal separators. The first oxidizing gas flow field extends through the first porous body in the thickness direction of the first porous body, and is connected to the second oxidizing gas flow field.

### CITATION LIST

### Patent Literature

Patent Literature 1: JP 2009-283196 A
Patent Literature 2: JP 2012-226981 A
Patent Literature 3: JP 2009-252426 A
Patent Literature 4: JP 2020-057548 A

### SUMMARY

### Technical Problem

When a porous body is used for a gas path in a cathode, for full performance thereof, a flat plate is arranged on one side of the porous body: the other side thereof is in contact with a gas diffusion layer. A metal porous body, however, leads to insufficient gas diffusivity, and a large pressure drop in the path, which are problematic.

In view of these problems, an object of the present disclosure is to provide a fuel cell that has excellent gas diffusivity and that can lead to suppressed pressure drop even with a porous body as a gas path.

### Solution to Problem

The present application is a fuel cell comprising: plural stacked power generating unit cells each having a membrane assembly, an anode separator stacked on the membrane assembly on one side, and a cathode separator stacked on the membrane assembly on another side, wherein the anode separator of any one of the power generating unit cells is stacked on the cathode separator of another one of the power generating unit cells that is adjacent to said any one, the cathode separator has a porous body where an oxidizing gas flows, and a path enlarging member, and the path enlarging member includes gas path enlarging portions that enlarge a path formed by the porous body, the gas path enlarging portions having wall parts inclining or orthogonal to a direction where the oxidizing gas flows.

In the fuel cell, the gas path enlarging portions may be grooves.

In the fuel cell, the grooves may wavily extend.

The fuel cell may further comprise: a cooling water path enlarging portion between adjacent ones of the gas path enlarging portions, the cooling water path enlarging portion enlarging a cooling water path of the anode separator.

### Advantageous Effects

The present disclosure enables a fuel cell to have excellent gas diffusivity and to lead to suppressed pressure drop even with a porous body as a gas path.

### BRIEF DESCRIPTION OF DRAWINGS

FIG. 1 illustrates structure of a fuel cell 1;

FIG. 2 is a plan view of power generating unit cells 10;

FIG. 3 shows a cross section of a power generating portion 11, and illustrates layer structure in the power generating portion 11;

FIG. 4 is an external perspective view illustrating structure of a cathode separator 20;

FIG. 5 is a cross-sectional view illustrating the structure of the cathode separator 20;

FIG. 6 shows one example of a porous body 21;

FIG. 7 shows an example of grooves 22a and 22c in the form of a semi-ellipse;

FIG. 8 illustrates a form of a path enlarging member 22′;

FIG. 9 illustrates another form of the path enlarging member 22′;

FIG. 10 is an external perspective view illustrating a form of a path enlarging member 122;

FIG. 11 is a cross-sectional view illustrating the form of the path enlarging member 122;

FIG. 12 is an external perspective view showing part of an anode separator 17;

FIG. 13 is an external perspective view showing the stacked cathode separator 20 and anode separator 17 of adjacent power generating unit cells 10, respectively;

FIG. 14 is a cross-sectional view of FIG. 13;

FIG. 15 is another cross-sectional view of FIG. 13; and

FIG. 16 illustrates flows of an oxidizing gas and cooling water.

### DESCRIPTION OF EMBODIMENTS

### 1. Fuel Cell

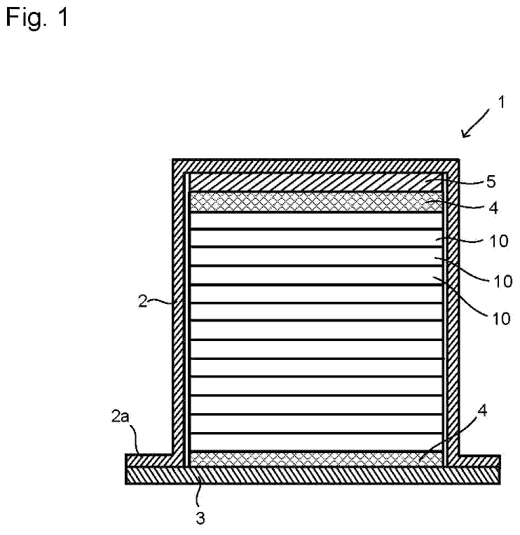

A fuel cell is a member formed by stacking plural (approximately 50 to 400) power generating unit cells, and collects currents from the plural power generating unit cells. FIG. 1 schematically shows the structure of a fuel cell. A fuel cell 1 is provided with a case for a stack 2, an end plate 3, plural power generating unit cells 10, current collector plates 4, and a biasing member 5.

The case for a stack 2 is a housing that houses the plural stacked power generating unit cells 10, the current collector plates 4, and the biasing member 5 thereinside. In this embodiment, the case for a stack 2 is in the form of a quadrangular tube with one open end and the other closed end. A board-like piece overhangs along the edge of the opening in the open end outwards from the opening to form a flange 2a.

The end plate 3 is a board-like member, and covers the opening of the case for a stack 2. The end plate 3 is arranged so as to cover the case for a stack 2 and is fixed with bolts and nuts or the like on a superposed portion of the end plate 3 and the flange 2a of the case for a stack 2.

The structure of the power generating unit cells 10 will be described later in detail. In the fuel cell 1, the plural power generating unit cells 10 are stacked.

The current collector plates 4 are members that collect currents from the stacked power generating unit cells 10. Therefore, the current collector plates 4 are arranged on both ends of a stack of the power generating unit cells 10, respectively. One of the current collector plates 4 is a cathode, and the other thereof is an anode. Terminals (not shown) are connected to these current collector plates 4, which enables electrical connection to the outside.

The biasing member 5 is stored inside the case for a stack 2. With the biasing member 5, a pressing force is applied to the stack of the power generating unit cells 10 in the stacking direction. An example of the biasing member is a disc spring.

### 2. Power Generating Unit Cell

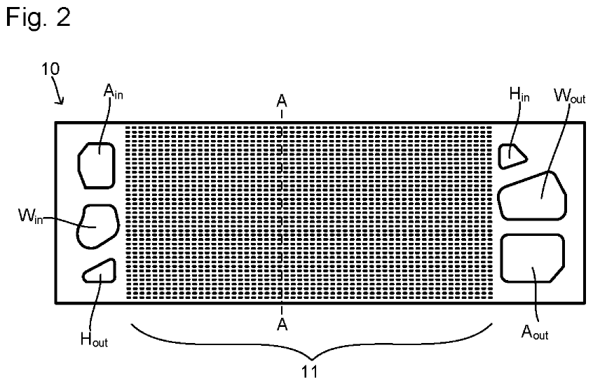

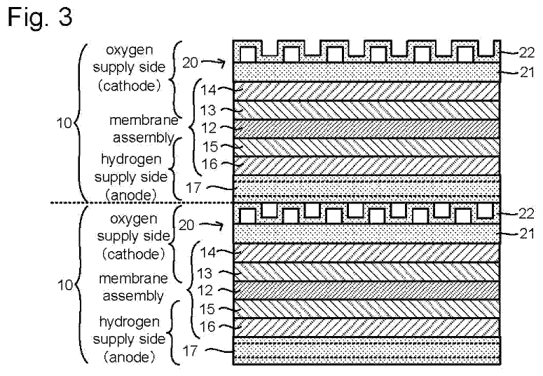

FIGS. 2 and 3 each illustrate the power generating unit cells 10 according to one embodiment. The power generating unit cells 10 are each a unit element for generating electricity by the supply of hydrogen and oxygen (air). As described above, the plural power generating unit cells 10 are stacked to constitute the fuel cell 1.

FIG. 2 is a plan view of the power generating unit cells 10, and FIG. 3 illustrates the layer structure in a power generating portion 11 in a cross section taken along A-A, and focuses on two stacked power generating unit cells 10.

The power generating portion 11 is a portion that contributes to the generation of electricity. As can be seen from FIG. 3, the power generating portion 11 is formed by stacking plural layers.

In each of the power generating unit cells 10, across an electrolyte membrane 12, one side of the power generating portion 11 is a cathode (oxygen supply side) and the other side thereof is an anode (hydrogen supply side). The cathode is formed by stacking a cathode catalyst layer 13, a cathode gas diffusion layer 14, and a cathode separator 20 in this order from the electrolyte membrane 12 side. The anode is provided with an anode catalyst layer 15, an anode gas diffusion layer 16, and an anode separator 17 in this order from the electrolyte membrane 12 side. A stack formed of the electrolyte membrane 12, the cathode catalyst layer 13, the cathode gas diffusion layer 14, the anode catalyst layer 15, and the anode gas diffusion layer 16 may be referred to as a membrane assembly. The membrane assembly herein typically has a thickness of approximately 0.4 mm. The thickness of a portion of the power generating unit cell 10 which includes the power generating portion 11 is typically approximately 1.3 mm.

2.1 Electrolyte Membrane

The electrolyte membrane 12 is a solid polymer thin film that exhibits excellent proton conductivity in a wet state. The electrolyte membrane 12 is formed of, for example, a fluorine-based ion exchange membrane. For the electrolyte membrane 12, a carbon-fluorine-based polymer can be used. Specific examples of this carbon-fluorine-based polymer include perfluoroalkylsulfonic acid polymers (Nafion (registered trademark)). The thickness of the electrolyte membrane 12 is not particularly limited, but is at most 100 μm, preferably at most 50 μm, and more preferably at most 30 μm.

2.2 Cathode Catalyst Layer

The cathode catalyst layer 13 is a layer that contains a catalytic metal supported by a carrier. Examples of the catalytic metal herein include Pt, Pd, Rh, and alloys each containing any of them. Examples of the carrier herein include carbon carriers; and more specific examples thereof include carbon particles each made from glassy carbon, carbon black, activated carbon, coke, natural graphite, artificial graphite, or the like.

2.3 Anode Catalyst Layer

The anode catalyst layer 15 is, as well as the cathode catalyst layer 13, a layer that contains a catalytic metal supported by a carrier. Examples of the catalytic metal herein include Pt, Pd, Rh, and alloys each containing any of them. Examples of the carrier herein include carbon carriers; and more specific examples thereof include carbon particles each made from glassy carbon, carbon black, activated carbon, coke, natural graphite, artificial graphite, or the like.

2.4 Cathode Gas Diffusion Layer

The cathode gas diffusion layer 14 can be formed of, for example, an electroconductive porous body. More specific examples of the material of the cathode gas diffusion layer 14 include porous carbon (including carbon papers, carbon cloths, and glassy carbon), and porous metals (including metal meshes and metal foams).

The cathode gas diffusion layer may be provided with an MPL (microporous layer) if necessary. The MPL herein is a coating-like thin film with which the cathode gas diffusion layer 14 is coated on the cathode catalyst layer 13 side. The MPL has a function of adjusting a moisture content with water repellency and hydrophilicity thereof if necessary. The MPL typically contains, as principal components, a water repellent resin such as polytetrafluoroethylene (PTFE), and an electroconductive material such as carbon black.

2.5 Anode Gas Diffusion Layer

The anode gas diffusion layer 16 can be formed of, for example, an electroconductive porous body. More specific examples of the material of the anode gas diffusion layer 16 include porous carbon (including carbon papers, carbon cloths, and glassy carbon), and porous metals (including metal meshes and metal foams).

2.6 Cathode Separator

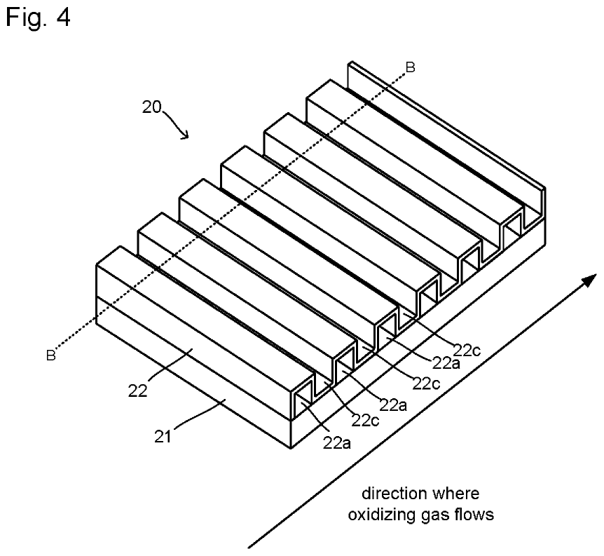

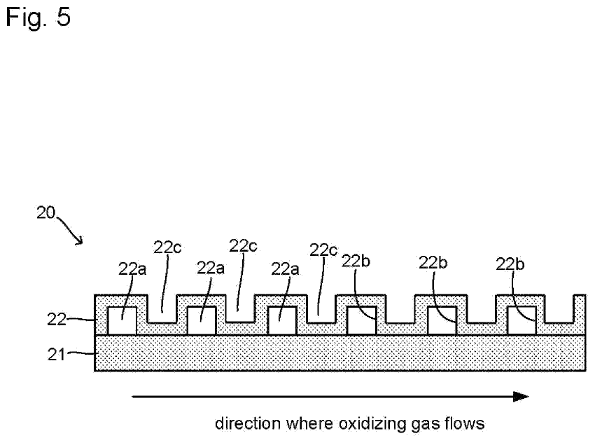

The cathode separator 20 is a member via which an oxidizing gas (air in this embodiment) is supplied to the cathode gas diffusion layer 14. FIG. 4 is a perspective view of part of the cathode separator 20 which includes the power generating portion 11 according to one embodiment. FIG. 5 is a cross-sectional view of the cathode separator 20 taken along B-B in FIG. 4. As can be seen from FIGS. 4 and 5, the cathode separator 20 has a porous body 21 and a path enlarging member 22.

2.6.1. Porous Body

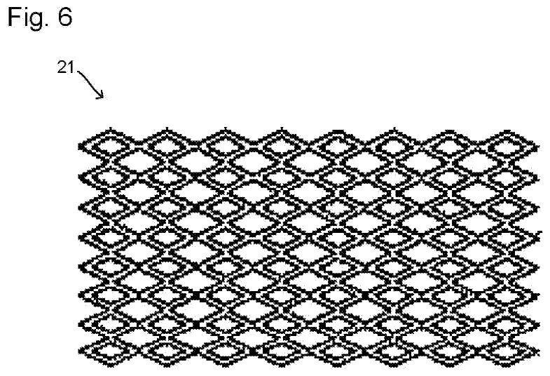

The porous body 21 is a member provided with countless pores through which gas can pass. A specific aspect of the porous body 21 is not particularly limited as long as the porous body 21 is provided with countless pores. However, the porous body 21 is preferably constituted of a metallic material. More specific examples of the metallic material herein include expanded metals, sintered metal foams, metal meshes, and punching metals. FIG. 6 shows part of expanded metal as one example. As can be seen from FIG. 6, the expanded metal, which is a porous body in this embodiment, is constituted of countless rhombic frames that are made from a metal and are arranged so that the frames align vertically and horizontally. The insides of the rhombic frames constitute pores.

2.6.2. Path Enlarging Member

The path enlarging member 22 is a member that is stacked on the porous body 21 on one side: on the other side, the porous body 21 is layered on the cathode gas diffusion layer 14. The path enlarging member 22 has plural grooves 22a that open on a face thereof which faces the porous body 21. These grooves 22a function as portions that enlarge a path of the oxidizing gas flowing in the porous body 21 (gas path enlarging portions). This gas path enlarging portions have wall parts 22b extending in a direction inclining or orthogonal to (not parallel to) the direction where the oxidizing gas flows, which is indicated by the arrows in FIGS. 4 and 5. In the present embodiment, the direction where the grooves 22a (gas path enlarging portions) extend is orthogonal to the direction where the oxidizing gas flows.

This can promote the diffusion of the oxidizing gas through the cathode gas diffusion layer 14, and can suppress a pressure drop, which will be described in detail later.

The path enlarging member 22 according to the present embodiment is further provided with grooves 22c each between any adjacent grooves 22a. The grooves 22c open opposite the side where the grooves 22a open. A set of the grooves 22a and a set of the grooves 22c are arranged on either side, respectively, across the path enlarging member 22, and do not communicate with each other.

These grooves 22c of one of the two adjacent power generating unit cells 10 open to the anode separator 17 of the other one thereof, and function as portions enlarging cooling water paths (grooves 17b) included in the anode separator 17 (cooling water path enlarging portions). The enlargement of the cooling water paths will be described later.

The depth of the grooves 22a and 22c, the pitch between adjacent grooves 22a (center distance between adjacent grooves 22a), and the pitch between adjacent grooves 22c (center distance between adjacent grooves 22c) can be appropriately adjusted in view of the pressure drop. The depth can be 0.1 mm to 0.4 mm, and the pitches each can be 0.5 mm to 2.5 mm.

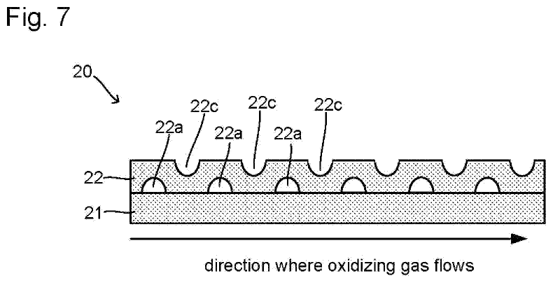

It is not necessary that the shape of the grooves 22a and 22c is a square as in the present embodiment. The shape may be a rectangle, a trapezoid, a semicircle, a semi-ellipse as shown in FIG. 7, a triangle, or any other definite or indefinite geometric form.

The material constituting the path enlarging member 22 may be any material that can be used for a separator for a power generating unit cell, and may be a gas-impermeable electro conductive material. Examples of such a material include dense carbon that is formed by compressing carbon to be impermeable to gasses, and press-molded metal plates.

As can be seen from FIG. 2, at a portion located outside the power generating portion 11 on the extension of the path enlarging member 22 from the power generating portion 11, the cathode separator 20 is further provided with an air inlet port Aᵢₙ, a cooling water inlet port Wᵢₙ, and a hydrogen outlet port Hₒᵤₜ on the side of one ends of the porous body 21 and the path enlarging member 22; and an air outlet port Aₒᵤₜ, a cooling water outlet port Wₒᵤₜ, and a hydrogen inlet port Hᵢₙ on the side of the other ends thereof. Here, the porous body 21 communicates with the air inlet port Aᵢₙ on one end side thereof, and the air outlet port Aₒᵤₜ on the other end side thereof.

### Other Embodiments of Path Enlarging Member

### Other Embodiment 1

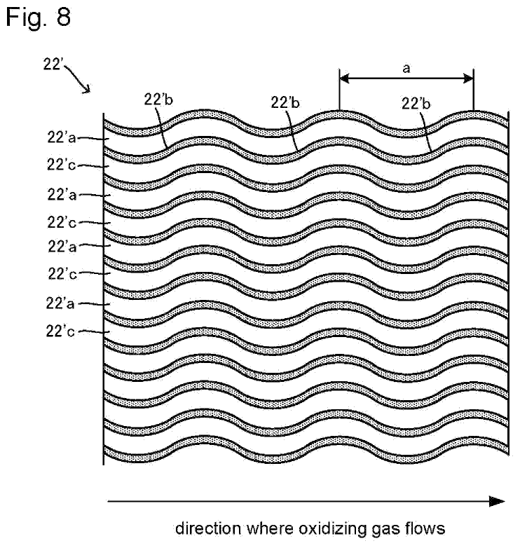

FIG. 8 illustrates a path enlarging member 22′ according to other embodiment 1. FIG. 8 shows the form of grooves 22′a that form gas path enlarging portions and grooves 22′c that form cooling water path enlarging portions in a plan view of part of the path enlarging member 22′ (from the viewpoint of FIG. 1). As well as the path enlarging member 22, the grooves 22′a and the grooves 22′c open on either side of the path enlarging member 22′, and are arranged alternately.

Unlike the path enlarging member 22, the grooves 22′a and 22′c according to the present embodiment extend in the direction where the oxidizing gas flows as a whole. The grooves 22′a and 22′c have wall parts 22′b extending in a direction inclining or orthogonal (not parallel) to the direction where the oxidizing gas flows since the grooves 22′a and 22′c are in a wavily extending form, and thus, wall faces thereof wind. These wall parts 22′b bring about the effect same as the wall parts 22b of the path enlarging member 22.

In the present embodiment, the interval between the tops of the waves of the grooves 22′a (the size a in FIG. 8) can be appropriately adjusted in view of the pressure drop, but can be 0.5 mm to 2.5 mm.

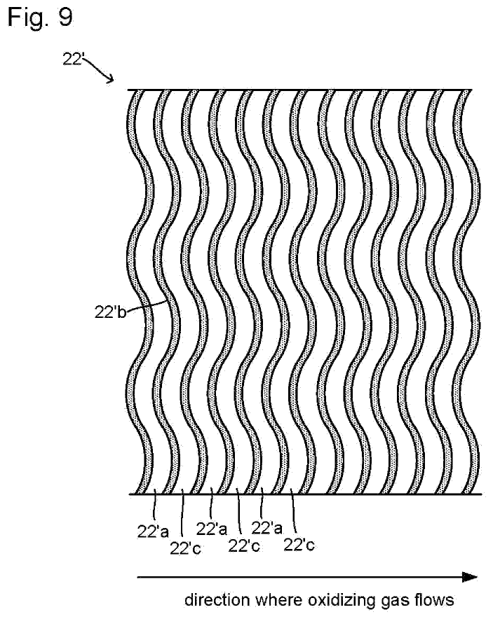

As shown in FIG. 9, the path enlarging member 22′ may be formed in such a manner that the direction where the grooves 22′a and 22′c extend is orthogonal to the direction where the oxidizing gas flows. In this case, the form of the grooves 22′a and 22′c is the same as that in the path enlarging member 22 except that the grooves 22′a and 22′c are in a wavily extending form.

The wave form of the wavily extending form is not particularly limited, but may be repeating curves in combination as in FIGS. 8 and 9, a triangular wave, a sinusoidal wave, a square wave, or any other indefinite wave.

### Other Embodiment 2

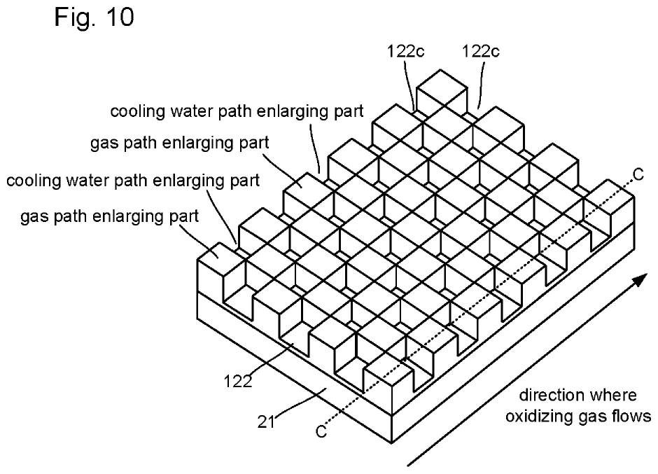

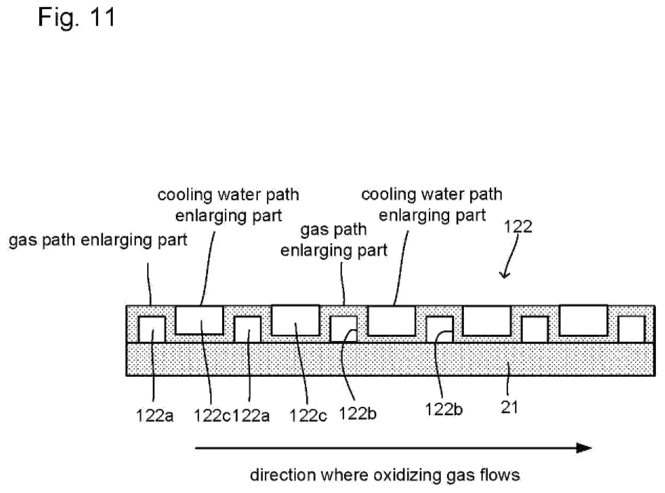

FIGS. 10 and 11 show part of a path enlarging member 122 according to other embodiment 2 together with the porous body 21. The porous body 21 is as described above. FIG. 10 is an external perspective view, and FIG. 11 is a cross-sectional view taken along C-C in FIG. 10.

In the path enlarging member 22, the grooves 22a (gas path enlarging portions) and the grooves 22c (cooling water path enlarging portions) extend in the direction where the oxidizing gas flows, and are aligned in the direction orthogonal to this extending direction. In this path enlarging member 122 according to the other embodiment 2, grooves 122a (gas path enlarging portions) and grooves 122c (cooling water path enlarging portions) are repeatedly aligned in both the extending direction and the orthogonal direction (that is, in the in-plane direction of the porous body 21).

In such an embodiment, wall parts 122b extending in a direction inclining or orthogonal (not parallel) to the direction where the oxidizing gas flows are also provided. These wall parts 122b bring about the effect same as the wall parts 22b of the path enlarging member 22.

2.7 Anode Separator

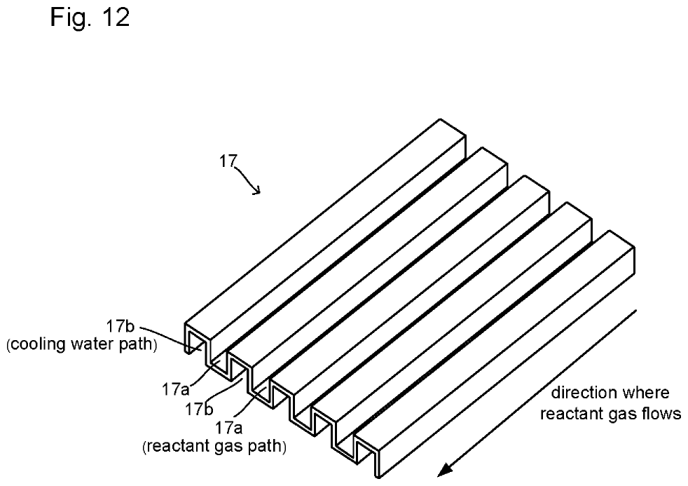

The anode separator 17 is a member via which a reactant gas (hydrogen) is supplied to the anode gas diffusion layer 16. FIG. 12 is an external perspective view showing part of the anode separator 17.

The anode separator 17 is a member that is stacked on the anode gas diffusion layer 16. The anode separator 17 has the plural grooves 17a that open on a face thereof which faces the anode gas diffusion layer 16. These grooves 17a are paths via which the reactant gas (hydrogen) is supplied to the anode gas diffusion layer 16. Therefore, the grooves 17a extend in the direction where the reactant gas flows, which is indicated by the straight arrow in FIG. 12.

The anode separator 17 according to the present embodiment is further provided with grooves 17b each between adjacent grooves 17a. The grooves 17b open opposite the side where the grooves 17a open. A set of the grooves 17a and a set of the grooves 17b are arranged on either side, respectively, across the anode separator 17, and do not communicate with each other.

These grooves 17b of one of the two adjacent power generating unit cells 10 open to the grooves 22c of the cathode separator 20 of the other one thereof to be cooling water flow paths.

The depth of the grooves 17a and 17b, the pitch between adjacent grooves 17a (center distance between adjacent grooves 17a), and the pitch between adjacent grooves 17b (center distance between adjacent grooves 17b) can be appropriately adjusted in view of the pressure drop. The depth can be 0.1 mm to 0.4 mm, and the pitches each can be 0.5 mm to 2.5 mm.

It is not necessary that the cross-sectional shape of the path of each of the grooves 17a and 17b is a square as in the present embodiment. The shape may be a rectangle, a trapezoid, a semicircle, a semi-ellipse, a triangle, or any other definite or indefinite geometric form.

The material constituting the anode separator 17 may be any material that can be used for a separator for a power generating unit cell, and may be a gas-impermeable electro conductive material. Examples of such a material include dense carbon that is formed by compressing carbon to be impermeable to gasses, and press-molded metal plates.

As can be seen from FIG. 2, at a portion located outside on the extension from the power generating portion 11, the anode separator 17 is further provided with the air inlet port Aᵢₙ, the cooling water inlet port Wᵢₙ, and the hydrogen outlet port Hₒᵤₜ on the side of one ends of the grooves 17a and 17b; and the air outlet port Aₒᵤₜ, the cooling water outlet port Wₒᵤₜ, and the hydrogen inlet port Hᵢₙ on the side of the other ends thereof. Here, the grooves 17a communicate with the hydrogen inlet port Hᵢₙ and the hydrogen outlet port Hₒᵤₜ; and the grooves 17b communicate with the cooling water inlet port Wᵢₙ and the cooling water outlet port Wₒᵤₜ.

2.8 Generation of Electricity in Power Generating Portion

Electricity is generated as known by the power generating unit cell 10 as follows.

When hydrogen is supplied via the grooves 17a of the anode separator 17, the hydrogen passes through the anode gas diffusion layer 16, and is resolved in the anode catalyst layer 15 into protons (H⁺) and electrons (e⁻). The protons pass through the electrolyte membrane 12, and the electrons pass through a conducting wire that connects to the outside, to each reach the cathode catalyst layer 13. Here, oxygen (air) is supplied to the cathode catalyst layer 13 from the cathode separator 20 via the cathode gas diffusion layer 14, and water (H2O) is generated in the cathode catalyst layer 13 by the protons, the electrons, and the oxygen. The generated water passes through the cathode gas diffusion layer 14 to reach the cathode separator 20, and is discharged.

That is, in the power generating unit cell 10, the flow of the electrons passing from the anode catalyst layer 15 through the conducting wire, which connects to the outside, is utilized as an electric current.

### 3. Effect Etc.

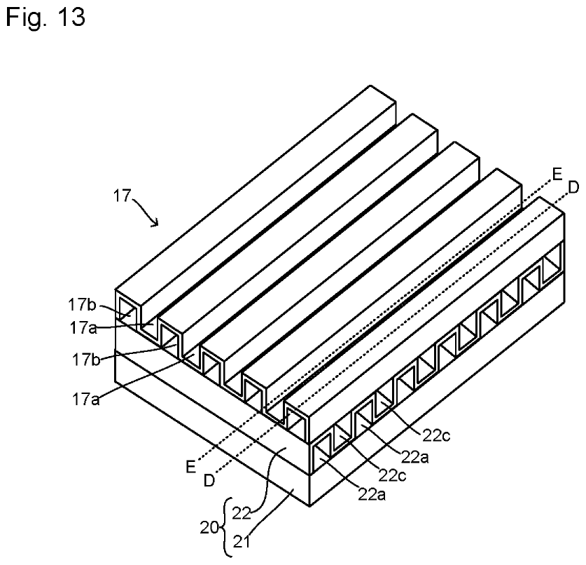

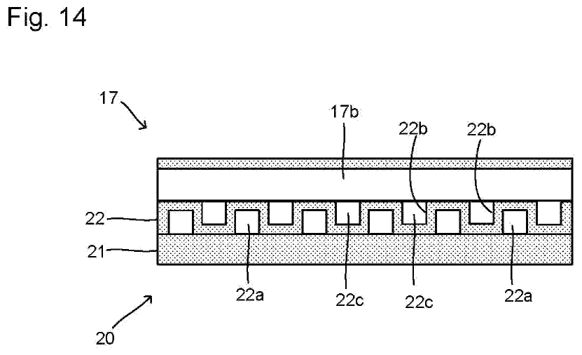

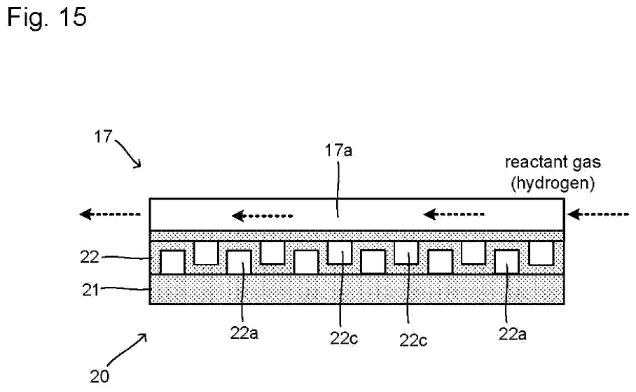

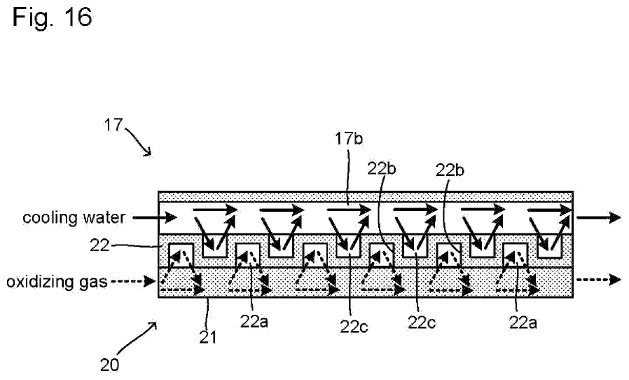

Electricity is generated as described above in the power generating unit cell 10 and the fuel cell 1 having the stack of the power generating unit cells 10. At this time, the stacked cathode separator 20 and anode separator 17 of adjacent power generating unit cells 10, respectively, function as follows. FIGS. 13 to 16 focus on and illustrate a superposed portion of the stacked cathode separator 20 and anode separator 17. FIG. 13 is an external perspective view, FIG. 14 is a cross-sectional view taken along the line D-D in FIG. 13 (a cross-sectional view showing the cooling water paths), FIG. 15 is a cross-sectional view taken along the line E-E in FIG. 13 (a cross-sectional view showing the reactant gas paths), and FIG. 16 shows a cross section in the same view point of FIG. 14, and illustrates the flows of the oxidizing gas and cooling water. Hereinafter the oxidizing gas, the cooling water, and the reactant gas will be each described.

3.1. Oxidizing Gas

The oxidizing gas supplied from Aᵢₙ shown in FIG. 2 flows in the porous body 21 of the cathode separator 20 toward Aₒᵤₜ.

As shown by the dotted arrows in FIG. 16, the oxidizing gas flows in the porous body 21: the gas path enlarging portions (grooves 22a, 22′a, and 122a) enlarge the path in the middle of the flow, and the wall parts 22b (22′b, and 122b) return the oxidizing gas to the porous body 21. Narrowing the once enlarged path causes the flow rate of the oxidizing gas to increase according to the Venturi effect, and the pressure at this portion to decrease according to the Bernoulli's principle. This causes most of the gas to flow into the porous body 21 having a lower pressure, which can improve the diffusion effect of the oxidizing gas.

The gas path enlarging portions (grooves 22a, 22′a, and 122a) enlarge the path, which can suppress the pressure drop in the oxidizing gas path. Particularly, in the example shown in FIG. 8, the effect of suppressing the pressure drop is strong since the gas path enlarging portions (grooves 22′a) are wavy grooves extending in the direction where the oxidizing gas flows. In addition, the flow rate of the oxidizing gas increases particularly in the vicinity of the points of inflection of the wave form, which promotes the influx of the oxidizing gas to the porous body 21.

3.2. Cooling Water

The cooling water supplied from Wᵢₙ shown in FIG. 2 flows in the grooves 17b of the anode separator 17 toward Wₒᵤₜ. As shown by the solid lines in FIG. 16, the cooling water path enlarging portions (grooves 22c) enlarge the paths in the middle of the flow. This enlarges the paths. At this time, the cooling water paths are enlarged by the path enlarging portions without any change of the anode separator 17 in thickness. Thus, it is not necessary to change the cross sections of the reactant gas paths (grooves 17a) of the anode separator 17. The enlargement of the cross-sectional areas of the reactant gas paths may lead to a decreased flow rate of the reactant gas more than expected. For example, a smaller flow quantity of the reactant gas leads to an insufficient flow rate thereof, which causes necessary diffusion of the reactant gas not to be obtained, and/or water discharge performance to deteriorate.

That is, according to the present embodiment, the cooling water path enlarging portions make it possible for the enlargement of the cooling water paths of the anode separator 17 to improve the cooling capacity without change in the reactant gas paths.

The cooling water path enlarging portions allow the cooling water to flow as moving also in the thickness direction of the power generating unit cell 10, which makes the cooling water turbulently flow moderately, can lead to uniform cooling and the achievement of uniform in-plane distribution of the generation of electricity, and improves the performance. When the cooling water path enlarging portions (grooves 22′c) are in the form of a wave as in the example of FIG. 8, and the reactant gas paths (grooves 17a) of the anode separator 17 are in the form of a straight line, the cooling effect is strong because both sets of the paths cross properly.

3.3. Reactant Gas (Hydrogen Gas)

The reactant gas (hydrogen gas) supplied from Hᵢₙ shown in FIG. 2 flows in the grooves 17a of the anode separator 17 as shown by the dotted arrows in FIG. 15 toward Hₒᵤₜ. In the present embodiment, the direction where the reactant gas (hydrogen gas) flows and the direction where the oxidizing gas and the cooling water flow are in relation to counterflow. This causes heat exchange to be efficient. This relation is not limited to the above, but may be parallel flow.

### REFERENCE SIGNS LIST

1 fuel cell
10 power generating unit cell
11 power generating portion
12 electrolyte membrane
13 cathode catalyst layer
14 cathode gas diffusion layer
15 anode catalyst layer
16 anode gas diffusion layer
17 anode separator
20 cathode separator

What is claimed is:

1. A fuel cell comprising:
plural stacked power generating unit cells each having a membrane assembly, an anode separator stacked on the membrane assembly on one side, and a cathode separator stacked on the membrane assembly on another side, wherein
the anode separator of any one of the power generating unit cells is stacked on the cathode separator of another one of the power generating unit cells that is adjacent to said any one,
the cathode separator has a porous body where an oxidizing gas flows, and a path enlarging member, and
the path enlarging member includes gas path enlarging portions that enlarge a path formed by the porous body, the gas path enlarging portions having wall parts inclining or orthogonal to a direction where the oxidizing gas flows.

2. The fuel cell according to claim 1, wherein the gas path enlarging portions are grooves.

3. The fuel cell according to claim 2, wherein the grooves wavily extend.

4. The fuel cell according to claim 1, further comprising:
a cooling water path enlarging portion between adjacent ones of the gas path enlarging portions, the cooling water path enlarging portion enlarging a cooling water path of the anode separator.
